(19) United States
(12) Patent Application Publication
(10) Pub. No.: US 2016/0148092 A1
(43) Pub. Date: May 26, 2016

(54) SYSTEMS AND METHODS FOR DETERMINING ACTIVITY LEVEL AT A MERCHANT LOCATION BY LEVERAGING REAL-TIME TRANSACTION DATA

(71) Applicant: MasterCard International Incorporated, New York, NY (US)

(72) Inventor: ROHIT CHAUHAN, Somers, NY (US)

(73) Assignee: MASTERCARD INTERNATIONAL INCORPORATED, New York, NY (US)

(21) Appl. No.: 14/548,833

(22) Filed: Nov. 20, 2014

(51) Int. Cl. G06N 5/02; G06F 17/30; H04L 29/06; G06Q 30/02

(52) U.S. Cl. CPC G06N 5/02; G06Q 30/0205; G06F 17/30867; H04L 63/10

(57) ABSTRACT

Systems and methods provide information regarding the activity level associated with a point of interest. Authorization records can be stored regarding electronic/cashless payment transactions at one or more points of interest. Activity level, such as the number of transactions that are processed during a particular period of time and/or the duration of time between subsequent transactions processed can reflect the amount of time a consumer may spend or wait to be served at the one or more points of interest. Additionally, activity levels can suggest the desirability of visiting a particular point of interest. Accordingly, based on the stored authorization records, the level of activity at the one or more points of interest can be determined and provided to the consumer to allow the consumer to choose which point of interest to visit based on the consumer's needs and/or desires.

### TECHNICAL FIELD

The present disclosure is generally related to electronic transaction processing. More particularly, the present disclosure is directed to systems and methods for determining activity levels associated with a point of interest based on real-time payment transaction data.

### BACKGROUND

The use of payment cards for a broad spectrum of cashless transactions has become ubiquitous in the current economy, accounting for hundreds of billions of dollars in transactions during a single year. Important aspects involved with the use of payment cards are the authentication of the payor/consumer using the payment card, as well as the authorization of the transaction based upon the availability of monies in the payor's/consumer's bank.

### SUMMARY

In accordance with one embodiment, a method comprises accessing an authorization database to obtain a predetermined subset of authorization records pertaining to electronic transactions stored therein. The method further comprises determining delta values between successive authorization records of the predetermined subset of authorization records. Additionally still, the method comprises predicting an activity level at one or more merchants associated with the electronic transactions based on the determined delta values

In accordance with another embodiment, a non-transitory computer-readable medium has computer executable program code embodied thereon. The computer executable program code is configured to cause a computer system to determine a location of a user relative to retail establishments, and determine activity levels at one or more of the retail establishments based on an amount of electronic transaction activity in the one or more of the retail establishments. Moreover the computer executable program is configured to cause the computer system to provide an activity level status of the one or more of the retail establishments based on the determined activity levels.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1 illustrates an example payment card transaction processing system.

FIG. 2 illustrates an example payment card transaction processing system over which the activity level of a point(s) of interest can be determined.

FIG. 3 illustrates an example communications system in which various embodiments may be implemented.

FIG. 4 illustrates an example activity level map that can be output to a user in accordance with various embodiments.

FIG. 5 is a flow chart illustrating various operations that may be performed to authenticate a product in accordance with one embodiment.

FIG. 6 is a flow chart illustrating various operations that may be performed to authenticate a product in accordance with another embodiment.

FIG. 7 illustrates an example computing module that may be used in implementing features of various embodiments.

The drawings are described in greater detail in the description and examples below.

### DETAILED DESCRIPTION

The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

Transaction processing of electronic payments can include both an authorization side and a clearance side. The authorization side may involve the process of confirming that a cardholder has a sufficient line of credit to cover a proposed payment. The clearance side of the transaction may involve the process of moving funds from an issuing bank to an acquiring merchant bank. In accordance with various embodiments disclosed herein, systems and methods are provided for leveraging certain aspects of transaction processing in order to determine an activity level associated with a point of interest, such as a retail establishment, merchant, or other entity involved in processing transactions. In particular, the speed and/or the amount of transactions processed by/at a point of interest can be analyzed to estimate or predict how long a consumer would potentially have to wait to be serviced, e.g., purchase a desired product or service, whether the estimated/predicted amount of activity is commensurate with the consumer's desire to visit the point of interest, etc.

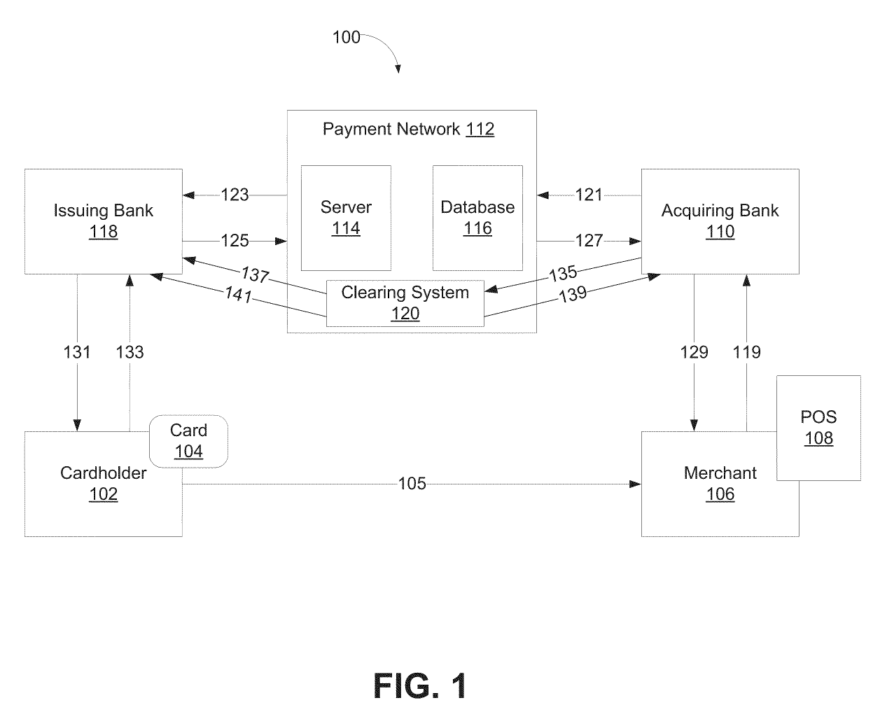

FIG. 1 depicts an example payment card transaction processing system 100 showing both the authorization side and the clearance side of card-based payments. In a typical card-based payment system transaction, a cardholder 102 presents a credit/debit/prepaid card 104 to a merchant 106 for the purchase of goods and/or services. This transaction is indicated by arrow 105. A “card” 104, as used herein, can refer to a conventional magnetic-stripe credit, debit card, or similar proximity payment device (utilized on its own or incorporated into another device such as a mobile telephone, personal digital assistant (PDA), etc.) having near field communications (NFC) capabilities, such as a radio frequency identification (RFID) chip implemented therein. A “card” 104 can further refer to virtual or limited use account numbers and electronic wallets.

It is understood that prior to the occurrence of such a transaction, cardholder 102 was issued card 104 by an issuing bank 118. Moreover, it will be understood that merchant 106 has established a relationship with an acquiring bank 110 (also referred to as a merchant bank), thereby allowing merchant 106 to receive cards as payment for goods and/or services. That is, acquiring banks and issuing banks, such as acquiring bank 110 and issuing bank 118, may participate in various payment networks, including payment network 112. One such payment network is operated by MasterCard International Incorporated, the assignee of the present disclosure.

After presentation of card 104 to merchant 106 by cardholder 102, merchant 106 may send an authorization request (indicated by arrow 119) to acquiring bank 110 via a point-of sale (POS) terminal 108 located at or otherwise controlled by merchant 106. In turn, acquiring bank 110 communicates with payment network 112 (indicated by arrow 121), and payment network 112 communicates with issuing bank 118 (indicated by arrow 123) to determine whether cardholder 102 is authorized to make transaction 105. The issuing bank 118 either approves or declines the authorization request and thereafter transmits the response back to merchant 106 (indicated by arrows 125, 127 and 129). Merchant 106 may then either complete or cancel transaction 105 based upon the response to the authorization request.

If transaction 105 is approved, in accordance with processes called clearing and settlement, the transaction amount will be sent from issuing bank 118 through payment network 112 to acquiring bank 110. The transaction amount, minus certain fees, will thereafter be deposited within a bank account belonging to merchant 106. Issuing bank 118 thereafter bills cardholder 102 (indicated by arrow 131) for all transactions conducted over a given period of time by sending a cardholder statement to cardholder 102. Cardholder 102 follows by submission of payment(s) (as indicated by arrow 133) to issuing bank 118. This submission of payment(s) (as indicated by arrow 133) by cardholder 102 may be automated (e.g., in the case of debit transactions), may be initiated by cardholder 102 for the exact amount matching amounts of purchases during the statement period (e.g., charge cards or credit balances paid in full), and/or may be submitted (in part or in whole) over a period of time that thereby reflects the amount of the purchases, plus any financing charges agreed upon beforehand between cardholder 102 and issuing bank 118 (e.g., revolving credit balances).

Payment network 112 preferably includes at least one server 114 and at least one database 116. Server 114 may include various computing devices such as a mainframe, personal computer (PC), laptop, workstation or the like. Server 114 can include a processing device and can be configured to implement an authorization and clearance process, which can be stored in computer storage associated with server 114. Database 116 may include computer readable medium storage technologies such as a floppy drive, hard drive, tape drive, flash drive, optical drive, read-only memory (ROM), random access memory (RAM), and/or the like. Server 114 and database 116 may be controlled by software/hardware and may store data to allow it to operate in accordance with aspects of the present disclosure.

POS terminal 108 is in data communication, directly or indirectly, and at least from time to time, with, e.g., an acquirer host computer (not shown) that is part of payment network 112 and is operated for or on behalf of acquiring bank 110, which handles payment card transactions for merchant 106. Server 114 may be operated by or on behalf of the payment network 112, and may provide central switching and message routing functions among the member financial institutions of the payment card network. Issuing bank 118 also preferably makes use of an issuer host computer (not shown), and an access point (not shown) via which the issuer host computer exchanges data messages with server 114. It should be noted that in practice, payment card transaction processing system 100 may involve a large number of cardholders, POS terminals, acquirer host computers, issuer host computers, and access points. In general, the acquirer host computer can receive authorization requests from POS terminals, forward the authorization requests through payment network 112, receive authorization responses, and relay the authorization responses to POS terminal 108. Moreover, the issuer host computer may in general, receive authorization requests from server 114 and transmit authorization responses back to server 114 with respect to the authorization requests.

It should be noted that the terms “authorization” and “authentication” may have distinct definitions in the context of electronic payment transactions. For example, the term authorization can refer to (as described above) the process by which issuing bank 118 approves or declines a transaction based on the availability of the requisite funds or other criteria. Authentication can refer to the process of establishing the identity of the cardholder, validity of card 104 and/or the account information associated with card 104 provided by cardholder 102. Authentication can be accomplished by manual processes such as verifying card ownership via physical ID (e.g., driver's license) and/or by utilizing one or more fraud prevention tools, such as an address verification service (AVS), card security codes (CVS)/card verification data (CVD), card verification code (CVC2), and the like. Moreover, merchant 106 may further utilize other authentication methods or processes including certain geolocation authentication mechanisms. In the case of debit payment transactions reliant upon the use of debit cards, a personal identification number (PIN) can be used for cardholder authentication. In accordance with various embodiments, authorization and/or authentication processes can be considered to be encompassed by the exchange of authorization information (e.g., authorization request and/or authorization responses/approval/decline messaging described herein).

Also included in a typical card-based payment system transaction are the clearing and settlement processes alluded to previously and described in greater detail below.

Clearing (which can happen after transmission of the authorization response if approved) can refer to a process by which issuing bank 118 exchanges transaction information with acquiring bank 110. Referring back to FIG. 1, acquiring bank 110 can transmit transaction information to a clearing system 120 (indicated by arrow 135). Clearing system 120 can validate the transaction information, and forward it to issuing bank 118 (indicated by arrow 137), which prepares data to be included on a payment statement for cardholder 102. Clearing system 120 may then provide reconciliation to both issuing bank 118 and acquiring bank 110 (indicated by arrows 139 and 141).

Settlement can refer to a process by which issuing bank 118 exchanges the requisite funds with acquiring bank 110 to complete an approved transaction. In particular, acquiring bank 110 may send clearing data in a clearing message to payment network 112, whereupon payment network 112 calculates a net settlement position and sends advisement to acquiring bank 110 and issuing bank 118. Issuing bank 118 can remit payment to payment network 112, which then sends the payment to acquiring bank 110. Acquiring bank 110 then pays merchant 106 for the purchase made by cardholder 102, and issuing bank 118 bills cardholder 102 (as described above).

As alluded to previously, payment transactions can be processed quickly and efficiently through the use of payment card transaction processing systems, such as payment card transaction processing system 100. This speed and efficiency is advantageous in an age where consumers are increasingly concerned with accomplishing more tasks in a shorter amount of time, whether those tasks are related to their professional lives or personal lives. Additionally, with the advent of mobile communications and the ability to obtain ever-increasing amounts of information electronically, consumers are seeking ways to leverage such information to assist in achieving such speed and efficiency, as well as enhance their decision-making process, e.g., in choosing when/where to engage in activities to suit their tastes/needs.

For example, the Yelp® service can provide a consumer with “peer” knowledge regarding preferred restaurants to dine at, and where those restaurants may be located relative to the consumer's location. The Yelp® service can be implemented on a PC or mobile device via a web-based application or mobile application, respectively, and can locate certain points of interest based on current or inputted location information, geographic range or proximity, etc. In the context of mobile devices, location-based services resident on/accessible by mobile devices, can be leveraged to ascertain a user's location. Based on that location, one or more points of interest, e.g., restaurants, local attractions, shopping establishments, social events, and the like can be presented to the user. Additionally, one or more filters/parameters based on a user's preferences can be applied, such as whether the user prefers to be presented with one or more points of interest relating to food, type of food, other attributes of the one or more points of interests, some user-determined proximity to the user's current location, or some combination thereof.

However, existing systems and methods utilized for recommending points of interest to a consumer are not capable of providing accurate and real-time information regarding how much activity or traffic these particular points of interest may be experiencing at a particular point in time. For example, if a user is under some time constraint, it would be advantageous for that user to be aware that visiting one establishment might result in a longer wait time versus visiting another establishment, e.g., the one establishment may have a longer service line as opposed to the other establishment. Additionally, it would be advantageous for the user to be aware that one establishment is experiencing more activity and thus, from a social standpoint, may be more desirable to visit or attend versus visiting an alternative establishment that is experiencing less activity.

As described above, authorization procedures are important in the context of cashless/electronic payment transactions. For example, and without the ability to verify that a person/entity making a payment is authorized to make payment using, e.g., a credit card, such payment transactions cannot be trusted and the system becomes compromised. The same holds true for ensuring that the person/entity has the requisite funds to complete the payment transaction. Accordingly, the generation and/or exchange of such information occurs in real-time.

In view of the above, various embodiments of the present disclosure leverage authorization procedures by storing information associated with each transaction process. Such stored information may be utilized to ascertain the time or duration between successive transaction processes and/or the amount of transactions that occur during a particular time period. This determined time or amount of transactions can be translated into the amount of activity that a particular point of interest is experiencing at a given time. For example, a short amount of time between transactions processed at a first establishment can indicate that a longer wait time would be experienced by a consumer than at a second establishment at which longer durations are experienced between transactions. This is because the shorter time periods between processed transactions can indicate the presence of more consumers engaging in purchase transactions, which in turn might suggest longer lines in which the consumer would have to wait. The same holds true for a greater number of processed transactions in a given time period at one establishment compared to another establishment, i.e., the more transactions processed can suggest more consumers present at the one establishment and thus, longer wait times can be expected.

In accordance with one embodiment, an activity level application, such as one that is implemented on a mobile device, PC, or other computing apparatus can be used to interact with a payment network to provide activity level information to a consumer. The activity level application can include a graphical user interface (GUI) or other interface with which a consumer can interact by searching for one or more points of interest proximate to the user. Along with the information regarding the existence and/or location of the one or more points of interest, additional information regarding anticipated wait times or activity levels can be provided via the application. Thus, the user may be given the opportunity to choose to visit the point of interest most desirable to the user, e.g., the point of interest at which the user would experience the least delay in making a purchase transaction, etc. Moreover, notifications can be provided to the user in real-time, allowing for up-to-date activity tracking of one or more points of interest. In this way, the consumer can make an informed decision regarding which point of interest to visit based on activity level.

It should be noted that other embodiments of the technology disclosed herein may implement alternative or combined metrics or analyses to estimate and/or predict activity or traffic levels at one or more points of interest via various predictive and/or analytic mechanisms or algorithms. For example, one such mechanism may translate shorter durations between transactions as suggesting that a first establishment is able to process transactions more quickly than a second establishment, which, from another perspective, may be advantageous to the consumer.

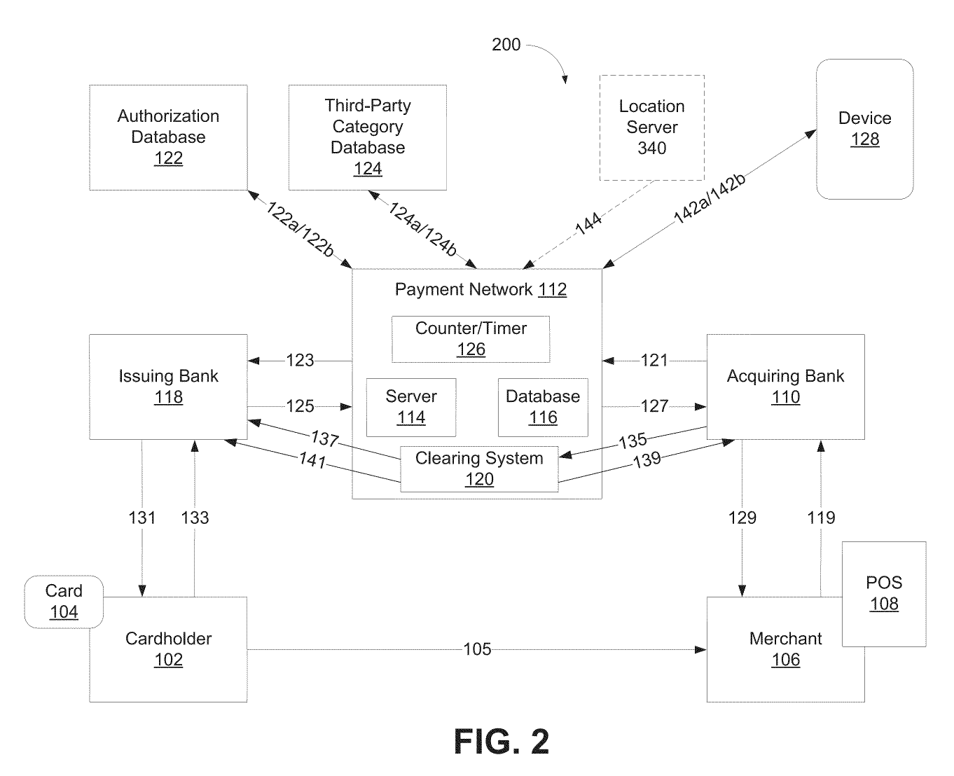

As alluded to above, authorization information is utilized to make the above determinations regarding activity level. FIG. 2 illustrates an example payment card transaction processing system 200 in which such authorization information can be leveraged to determine activity level in accordance with various embodiments. Elements of system 200 may be considered to be the same or similar to like-numbered elements of FIG. 1, e.g., cardholder 102, card 104, merchant 106, POS 108, acquiring bank 110, payment network 112 (and its example constituent elements), and issuing bank 118.

As previously described, and after presentation of card 104 to merchant 106 by cardholder 102, merchant 106 may send an authorization request including transaction data (indicated by arrow 119) to acquiring bank 110 via POS terminal 108 located at or otherwise controlled by merchant 106. In turn, acquiring bank 110 communicates with payment network 112 (indicated by arrow 121). Payment network 112, as also previously described, communicates with issuing bank 118 (indicated by arrow 123) to determine whether cardholder 102 is authorized to make transaction 105. The issuing bank 118 either approves or declines the authorization request and thereafter transmits the response back to merchant 106 (indicated by arrows 125, 127 and 129).

Additionally, payment network 112 can store authorization records associated with all transactions in an authorization database 122. Authorization database 122 may include one or more servers, processors, and/or databases that can receive and store authorization/authentication information gleaned from transactions processed by payment network 112.

Moreover, system 200 may include connectivity to a third-party category database 124, which can be provided by one or more entities that can link merchants to products sold or categories of establishments to which the merchants may belong. Through connectivity between payment network 112, authorization database 122, and/or third-party category database 124, payment network 112 can determine what points of interest are to be provided to a user depending on the desires/interests of the user. That is, payment network 112 is aware of the particular merchant, e.g., merchant 106, that may be associated with a particular set or subset of transactions. Third-party category database 124 can be accessed to associate merchant 106 with one or more categorizes of services and/or products that merchant 106 may sell. Further still, payment network 112 may include a counter/timer module 126 for counting transactions and/or the time between transactions. It should be noted that the time between transactions that is calculated by counter/timer module 126 may be averaged over a plurality of duration times between some predetermined number of transactions or that occur within a predetermined time period.

It should be noted that although FIG. 2 represents a single authorization database 122 and a single third-party category database 124, there can be multiple authorization and/or third-party category databases that payment network 112 can access, and such databases need not be centralized, but can be embodied as a distributed system(s)/network(s) of databases, or a hybrid combination of centralized and distributed databases.

In operation, an activity level application implemented on device 128 may query payment network 112 (indicated by arrow 142a) regarding the level of activity associated with one or more points of interest. Device 128 may be a mobile device, such as a tablet PC, laptop PC, smart phone, or similar device. Alternatively, device 128 may be a desktop PC or similar computing device. It should be noted that in some embodiments, card 102 may be integrated within device 128, such as in the case of an electronic wallet application running on device 128. The activity level application implemented on device 128 may be configured to present a consumer (e.g., a user of device 128) with an interface, such as a GUI, from which the consumer may request some listing of points of interest in which the consumer is interested in visiting. For example, the consumer may be interested in visiting a quick service restaurant that serves coffee within a 0.5 mile radius from the consumer's current location. Preferences in the form of parameters, filters, etc. may be input by the consumer via the GUI, such as the type of restaurant or food/drink the consumer desires, the preferred distance from a current location of the consumer, etc.

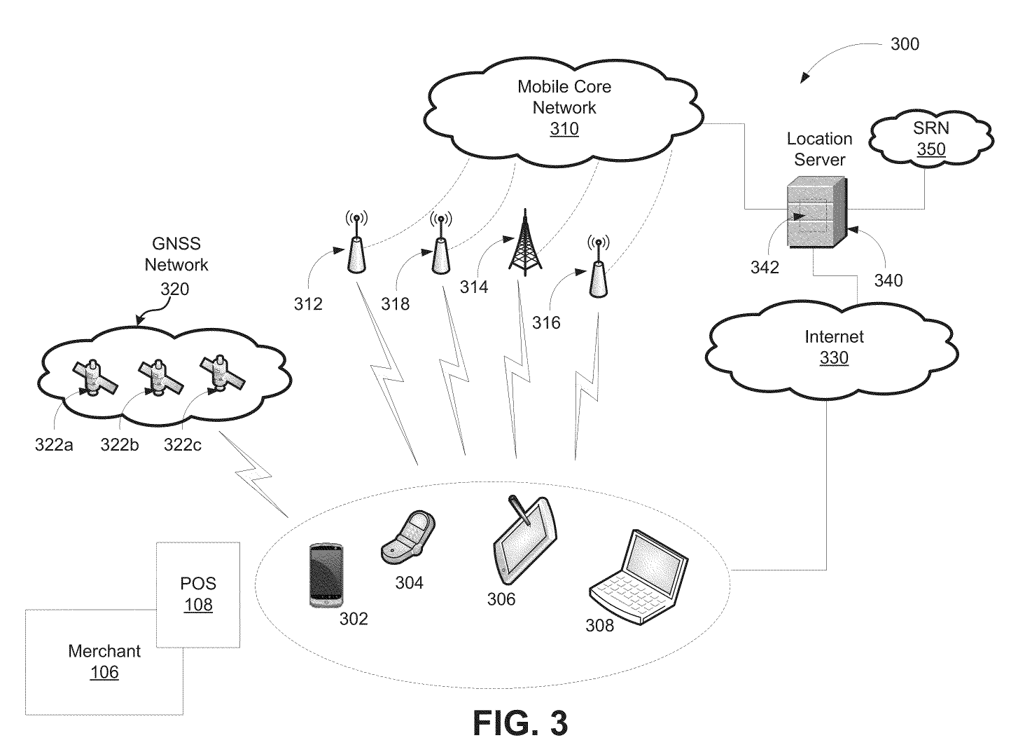

As will be discussed in greater detail below, location based services (LBS) resident on device 128 may be accessed to ascertain the consumer's current location. Alternatively, the activity level application may perform an API call to a third-party mapping application, such as Google Maps® or the Starbucks® web-based store locator application to obtain location information regarding one or more points of interest meeting the consumer's preferences. Alternatively still, server 114 may access a location server (e.g., location server 340 of FIG. 3 to be discussed in greater detail below) to obtain location information regarding device 128 and/or the one or more points of interest meeting the consumer's preferences. Alternatively still, various embodiments may involve implementation of the activity level functionality of the activity level application in a third-party mapping application or service, where the third-party mapping application or service may perform an API call to payment network 112 requesting activity level information.

As discussed above, the activity level application may be able to glean, e.g., geolocation information, regarding device 128 by leveraging LBS. FIG. 3 is a block diagram illustrating an example communication system 300 in which various embodiments may be implemented in accordance with the present disclosure. Communications system 300 may include a plurality of mobile devices, of which mobile devices 302-308 are illustrated. One or more of mobile devices 302-308 can include the aforementioned activity level application for determining activity level at one or more points of interest according to various embodiments described in the present disclosure. Example mobile devices may include a smart phone 302, a cellular device 304, a tablet PC 306, and/or a laptop PC 308. Also shown in communication system 300 is a mobile core network 310, a wireless access point (AP) 312, a cellular base station (BS) 314, a Bluetooth® emitter 316, a Near Field Communication (NFC) terminal 318, a global navigation satellite system (GNSS) network 320, a plurality of GNSS satellites 322a-322n, an internet 330, a location server 340, and a satellite reference network (SRN) 350. One or more of mobile core network 310, wireless AP 312, cellular BS 314, Bluetooth® emitter 316, NFC terminal 318, GNSS network 320, GNSS satellites 322a-322n, internet 330, location server 340, and/or satellite reference network (SRN) 350 can be used in assisting to determine the location of one or more of the mobile devices 302-308 for use in the activity level application and/or to provide communications links to the mobile devices 302-308 for allowing mobile devices 302-308 to communicate.

Wireless AP 312 may include suitable logic, circuitry, interfaces, and/or code that are operable to provide data services to communication devices, such as one or more of the mobile devices 302-308, in adherence with one or more wireless LAN (WLAN) standards such as, for example, IEEE 802.11, 802.11a, 802.11b, 802.11d, 802.11e, 802.11n, 802.11 ac, 802.11v, and/or 802.11u. Wireless AP 312 may communicate with mobile core network 310 and/or internet 330, via one or more links and/or associated devices for example. In this manner, wireless AP 312 may provide network access to mobile devices 302-308.

Cellular BS 314 may include suitable logic, circuitry, interfaces, and/or code that are operable to provide voice and/or data services to communication devices, such as one or more of the mobile devices 302-308, in adherence with one or more cellular communication standards. Exemplary cellular communication standards may include Global System for Mobile communications (GSM), General Packet Radio Services (GPRS), Universal Mobile Telecommunications System (UMTS), Enhanced Data rates for GSM Evolution (EDGE), Enhanced GPRS (EGPRS), and/or 3GPP Long Term Evolution (LTE). Cellular BS 314 may communicate with mobile core network 310 and/or internet 330, via one or more backhaul links and/or associated devices for example. In this manner, cellular BS 314 may provide network access to mobile devices 302-308, enabling a mobile device running the activity level application, such as smart phone 302, to communicate with one or more databases, services, servers, networks, such as a payment network, etc. as described herein.

Bluetooth® emitter 316 may include suitable logic, circuitry, interfaces, and/or code that are operable to provide Bluetooth® based connectivity to communication devices, such as one or more of mobile devices 302-308, in adherence with various Bluetooth® and/or Bluetooth® Low Energy (BLE) standards. Bluetooth® emitter 316 may communicate with mobile core network 310 and/or internet 330, via one or more backhaul links and/or associated devices for example. In this manner, Bluetooth® emitter 316 may provide network access to mobile devices 302-308, enabling a mobile device running an activity level application, such as smart phone 302 to communicate with one or more entities of system 300.

NFC terminal 318 may include suitable logic, circuitry, interfaces, and/or code that can provide NFC-based connectivity to communication devices, such as one or more of the mobile devices 302-308, in adherence with various short range communication standards such as the Near Field Communications standards. The NFC terminal 318 may communicate with the mobile core network 310 and/or the internet 330, via one or more backhaul links and/or associated devices for example. In this manner, the NFC terminal 318 may provide network access to the mobile devices 302-308. One example implementation of an NFC terminal 318 is for use in a contactless payment system and/or for communicating with, e.g., merchant 106/POS terminal 108.

Mobile core network 310 may include suitable logic, circuitry, interfaces, and/or code that are operable to provide interfacing and/or connectivity servicing between access networks, which may be utilized by the mobile devices 302-308, and external data networks such as packet data networks (PDNs) and/or internet 330. Mobile core network 310 may correspond to one or more service providers that provide, control, and/or manage network accessibility available via mobile devices 302-308. In this regard, mobile devices 302-308 may access the mobile core network 310 via wireless AP 312, cellular BS 314, Bluetooth® emitter 316, and/or NFC terminal 318. Mobile core network 310 may communicate various data services, which are provided by external data networks, to associated user devices such as, for example, mobile devices 302-308. In an example aspect of the disclosure, in instances where a an activity level application is provided to a user device such as smart phone 302, mobile core network 310 may be operable to communicate with location server 340 to obtain location information that can be used by the activity level application to, e.g., ascertain a location of merchant 106 and/or smart phone 302.

Each of mobile devices 302-308 may include suitable logic, circuitry, interfaces, and/or code for implementing various aspects of the embodiments disclosed herein. In this regard, each of mobile devices 302-308 may be operable to communicate via a plurality of wired and/or wireless connections. Each of mobile devices 302-308 may be operable, for example, to transmit to and/or receive signals from one or more of wireless AP 312, cellular BS 314, Bluetooth® emitter 316, NFC terminal 318, GNSS network 320, and/or internet 330. Also, each of mobile devices 302-308 may be operable to communicate with, and/or receive services provided by internet 330 and/or mobile core network 310. In this regard, mobile devices 302-308 may be operable to utilize an activity level application for determining activity levels at one or more points of interest, which can utilize location server 340.

GNSS network 320 may include suitable logic, circuitry, interfaces, and/or code that may provide navigation information to land-based devices via satellite links. In this regard, GNSS network 320 may include, for example, a plurality of GNSS satellites 322a-322n, each of which is operable to provide satellite transmissions based on a GNSS. Exemplary GNSS systems may include, for example, GPS, GLONASS, Galileo-based satellite system, Beidou and/or Compass systems. Accordingly, GNSS network 320 may be operable to provide positioning information via downlink satellite links transmitted from one or more of the plurality of GNSS satellites 322a-322n to enable land-based devices, such as the mobile devices 302-308, to determine their locations. The plurality of GNSS satellites 322a-322n may directly provide positioning information and/or a land-based device may utilize satellite transmissions from different satellites to determine its location using, for example, triangulation based techniques.

SRN 350 may include suitable logic, circuitry, interfaces, and/or code that are operable to collect and/or distribute data for GNSS satellites on a continuous basis. SRN 350 may include a plurality of GNSS reference tracking stations located around the world to provide A-GNSS coverage all the time in both a home network and/or any visited network. In this regard, SRN 350 may utilize satellite signals received from various GNSS constellations, such as, for example, the plurality of GNSS satellites 322a-322n of GNSS network 320.

Location server 340 may include suitable logic, circuitry, interfaces, and/or code that are operable to provide and/or support location based services. In this regard, location server 340 may be operable to store and/or process location related information pertaining to communication devices in system 300, such as one or more of mobile devices 302-308, as well as the location of other entities, such as points of interest, merchants, etc. It should be noted that location server 340 may access and/or communicate with other location servers/services (not shown) for the purpose of associating a location of communication devices in system 300 with known locations of other entities, points of interest, etc. The location information may be stored in a location reference database 342 in location server 340. Location server 340 may be operable to collect and/or retrieve location information from communication devices. Location server 340 may also be operable to access additional and/or dedicated entities, such as SRN 350 for example, to collect GNSS satellite data, and may be operable to utilize the collected GNSS satellite data to generate GNSS assistance data (A-GNSS data) including, for example, ephemeris data, long term orbit (LTO) data, reference positions and/or time information. Location server 340 may communicate the stored location data when requested to do so.

In operation, location server 340 may be utilized to provide LBS in system 300. Location server 340 may maintain, for example, location reference database 342, which may include elements corresponding to each of mobile devices 302-308. Location server 340 may access SRN 350 to collect GNSS satellite data, and may utilize the collected GNSS satellite data to generate GNSS assistance data (A-GNSS data) pertaining to the mobile devices 302-308. Location server 340 may also collect and/or retrieve location information directly from mobile devices 302-308, and/or from other associated entities that interact with mobile devices 302-308 in system 300, such as, for example, wireless AP 312, cellular BS 314, Bluetooth® emitter 316, and/or NFC terminal 318. The retrieved location information may be stored in location reference database 342 in location server 340. Location server 340 may communicate the stored location data, e.g., when requested to do so. Location reference database 342, maintained in location server 340, may be modified, refined, and/or updated using retrieved location information. Location information stored and/or maintained by location server 340 may be utilized to augment and/or substitute for location information received and/or generated based on communication with GNSS network 320, for example, when communication with GNSS network 320 is disturbed.

The location data may also be locally generated, and/or maintained thereafter by devices and/or entities other than location server 340. In this regard, location related data, which typically may be generated and/or maintained by location server 340, may be locally generated, maintained, and/or used by mobile devices 302-308, and/or by service providers thereof. Accordingly, devices and/or entities that typically may be serviced by location server 340, such as mobile devices 302-308, may also perform location related servicing locally. Furthermore, locally generated and/or maintained location related data may be uploaded from mobile devices 302-308, and/or service providers thereof, to location server 340. Uploading the location related data may be performed periodically, on request, and/or based on the configuration of the client devices or entities, and/or location server 340 itself.

The location information stored and/or maintained in location server 340 may be utilized to authenticate, for example, one or more of mobile devices 302-308, users thereof, and/or locations thereof during operations performed by mobile devices 302-308. In this regard, service providers, who may provide access servicing to mobile devices 302-308, may contact location server 340 to request that location server 340 perform authentication procedures, and/or to obtain information necessary for performing the authentication procedures. The service providers may include, for example, cellular, Bluetooth®, WLAN, and/or NFC services providers. For example, a service provider of one of mobile devices 302-308 may request authenticating the mobile device, its user, and location at a given instance. Location server 340 may then perform the necessary authentication procedures, which may be based on existing information in location reference database 342, which is maintained by location server 340. Location server 340 may also perform authentication procedures based on current information, which may be obtained by, for example, communicating with the mobile device, to verify its present location and/or connectivity status or parameters. In this regard, location server 340 may communicate with the mobile device using IP packets that may be communicated via internet 330, which may be transmitted to and/or received by the mobile device via its internet connectivity, and/or via its network access via wireless AP 312, cellular BS 314, Bluetooth® emitter 316, and/or NFC terminal 318.

Internet 330 may include a system of interconnected networks and/or devices that enable exchange of information and/or data among a plurality of nodes, based on one or more networking standards, including, for example, Internet Protocol (IP). Internet 330 may enable, for example, connectivity among a plurality of private and public, academic, business, and/or government nodes and/or networks, wherein the physical connectivity may be provided via the Public Switched Telephone Network (PSTN), utilizing copper wires, fiber-optic cables, wireless interfaces, and/or other standards-based interfaces.

Various devices and/or user identification information may be utilized during network access and/or communications, which may be structured, allocated, and/or assigned based on the specific wired and/or wireless protocols that are used to facilitate any such network access and/or communication. For example, in GSM and/or WCDMA based networks, International Mobile Equipment Identity (IMEI) parameters may be utilized to uniquely identify mobiles devices, and these IMEI parameters may also be used and/or traced back to the mobile devices' users. Service providers may utilize the device and/or user identification information to track mobile devices and/or users. The service providers may track devices and/or users for various reasons, including, for example, billing or usage monitoring, and/or to help locate mobile devices, and/or their users, in cases of emergency and/or law enforcement purposes. Tracking of devices may also be used to provide authorized LBS and/or real-time device location information which can be utilized by activity level applications, such as exemplary embodiments of the activity level application according to the present disclosure, running on the mobile device or other devices and/or systems.

Referring back to FIG. 2, various embodiments may leverage LBS as described with respect to FIG. 3 in order to determine the location of a device 128. That is, a consumer may request recommendations for points of interest proximate to the location of the consumer using the aforementioned activity level application. Again, payment network 112 may receive a query from device 128 (indicated by arrow 142a) regarding points of interest directed to quick service restaurants that serve coffee. It should be noted that the query can include location information regarding device 128. As alluded to above, payment network 112 may also query location server 340 to obtain the location of device 128 and/or relevant (appropriately proximate) points of interest (indicated by arrow 144). Payment network 112 may then access third-party category database 124 (indicated by arrow 124a) for entities that fall under the category of coffee-serving quick service restaurants.

In particular, payment network 112 may access third-party category database 124 to obtain, e.g., the names, identifiers, merchant identification number (MID), or other indicia indicative of the merchant(s) commensurate with or relevant to the query received. Third-party category database 124 may then return the indicia regarding the merchant(s) whose records are to be obtained from authorization database 122 (indicated by arrow 124b).

Upon receiving information regarding these entities, payment network 112 may perform a call to location server 340 to obtain the location of device 128 as well as the coffee-serving quick service restaurants that are proximate to device 128 (commensurate with, e.g., some distance specified by the consumer operating device 128). Upon identifying the relevant coffee-serving quick service restaurants, payment network 112 may access authorization database 122 (indicated by arrow 122a) to retrieve relevant transaction data associated with the relevant coffee-serving quick service restaurants (indicated by arrow 122b).

That is, payment network 112 may access authorization database 122 to obtain records of transactions processed for the relevant merchant(s) within a predetermined time period. The predetermined time period can be denoted within payment network 112 in accordance with the needs of or accuracy desired by payment network 112. Alternatively, the predetermined time period can be configured by the consumer via the activity level application implemented on device 128. For example, the payment network 112 can be instructed to obtain records of transactions processed within the last 5 minutes, 10 minutes, 30 minutes, etc. from the time the query was received by payment network 112.

Upon obtaining the requisite records, counter/timer module 126 can calculate the durations of time between successive transactions processed within the predetermined time period (e.g., delta values), and provide an average duration value. In accordance with other embodiments, counter/timer module 126 may calculate a value reflecting the number of transactions processed during the predetermined time period in addition to, or as an alternative to calculating the average duration value.

Thereafter, payment network 112 may return information regarding the average duration value information to device 128 (indicated by arrow 142b). In accordance with another embodiment, these values can be presented to the consumer via the activity level application in their “raw” format. In accordance with still another embodiment, one or more predictive or analytic mechanisms or algorithms can be applied to the average duration value and/or the number of transactions processed value to “enhance” the information. That is, and for example, a statistical trend analysis can be utilized to predict or estimate wait time based on the average duration value and the number of transactions processed value rather than providing raw information. In the case of returning enhanced information in a predictive format, payment network 112 may apply one or more predictive or analytical algorithms to translate, e.g., the average duration value information into a predicted or estimated wait time that the consumer would have to wait before being served at each of the relevant coffee-serving quick service restaurants.

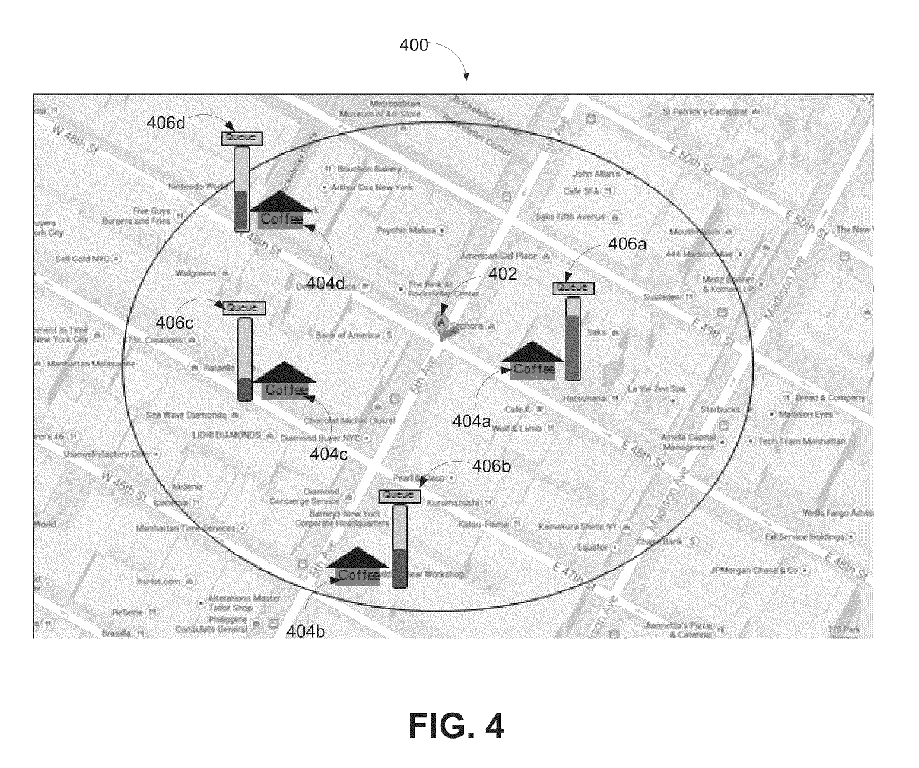

FIG. 4 illustrates an example map 400 that can be displayed to a consumer operating device 128 via the activity level application. Map 400 illustrates the determined location 402 of the consumer/device 128. Additionally, map 400 indicates the locations of any relevant points of interest 404a-404d that have been determined to match the criteria of the query for recommended points of interest transmitted by the activity level application to payment network 112. In addition to the locations of the recommended points of interest, activity levels (in this example, the predicted or estimated length of queues associated with the recommended points of interest) are shown at 406a-406d, respectively. Given this activity level information, the consumer can determine which point of interest to visit, e.g., based on the shortest queue associated with a recommended point of interest, which in this example, is recommended point of interest 404c.

It should be noted that the additional factors and/or parameters may be considered when presenting the activity level information to a consumer. For example, considerations such as whether the proximity information taken into account is walking proximity, driving proximity, and the like can be considered and factored into the presented activity level information. Payment network 112 can further access and/or perform calls to other location/information based services such as credit card parking space payment systems to determine time if parking is potentially available proximate to the relevant points of interest if proximity is based on driving proximity to a recommended point of interest. That is, any type of relevant or associated information system(s)s can be accessed, where the information gleaned therefrom can be applied to various embodiments, e.g., to provide further granularity or specificity to activity level determinations. Additionally, payment network 112 may determine activity level(s) associated with one or more merchants as described above periodically so that the consumer can be receive up-to-date activity level information.

It should be further noted that as described previously, various embodiment may be leverage existing and/or third-party mapping or location-based services/applications, such as the Yelp® service/application, Google Maps®, etc. That is, an existing mapping or location-based service/application can determine a user's location and recommend relevant points of interest based on a consumer's/user's preferences regarding a point of interest the consumer/user is interested in visiting. Once the recommended relevant points of interest are determined, payment network 112 may determine identification information associated with the recommended relevant points of interest, e.g., MIDs, and retrieve transaction processing information regarding those recommended relevant points of interest from authorization database 122. Determining the activity level associated with the recommended relevant points of interest can be then performed as described above.

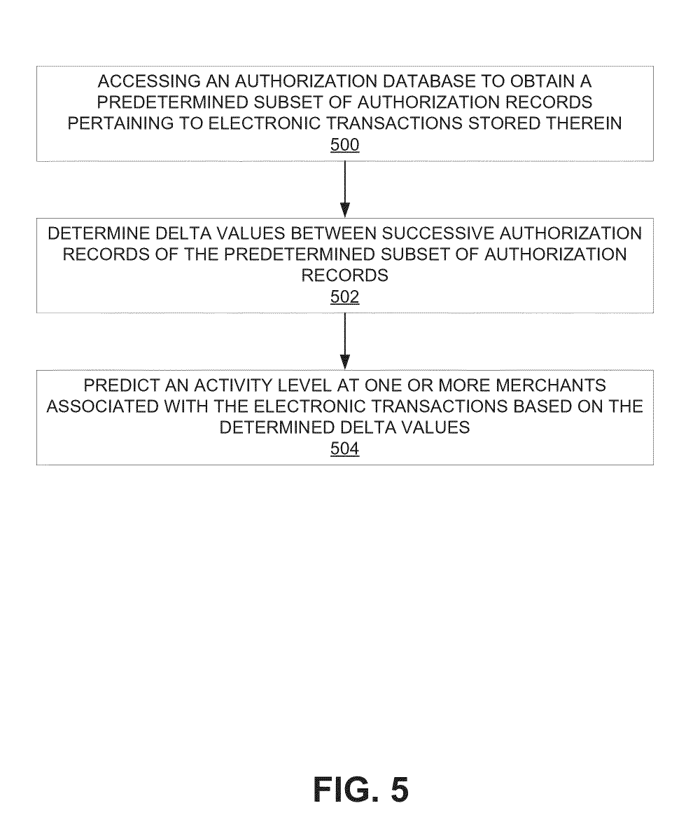

FIG. 5 illustrates a flow chart describing various processes that can be performed to determine the activity level associated with a point of interest in accordance with one embodiment of the present disclosure. At operation 500, an authorization database is accessed (e.g., by server 114 of payment network 112 illustrated in FIG. 2) to obtain a predetermined subset of authorization records pertaining to electronic transactions stored therein. As described above, the predetermined subset of authorization records may involve transaction information associated with one or more points of interest that are located proximate to a consumer's location. Moreover, the predetermined subset of authorization records can encompass those transactions processed within some predetermined time period, e.g., 5 minutes, 10 minutes, or 30 minutes, from the time the query is received. At operation 502, delta values between successive authorization records of the predetermined subset of authorization records are determined. For example, the delta values can be determined by calculating the time difference between transactions, where the time of each transaction can be ascertained by analyzing the time stamps associated with each of the successive authorization records. That is, the time between each successive transaction process is determined within the predetermined time period. It should be noted that the determination of delta values can be performed by server 114 in accordance with one embodiment or by counter/timer module 126 in accordance with another embodiment. At operation 504, an activity level at one or more merchants associated with the electronic transactions is predicted based on the determined delta values. This prediction can be performed by server 114.

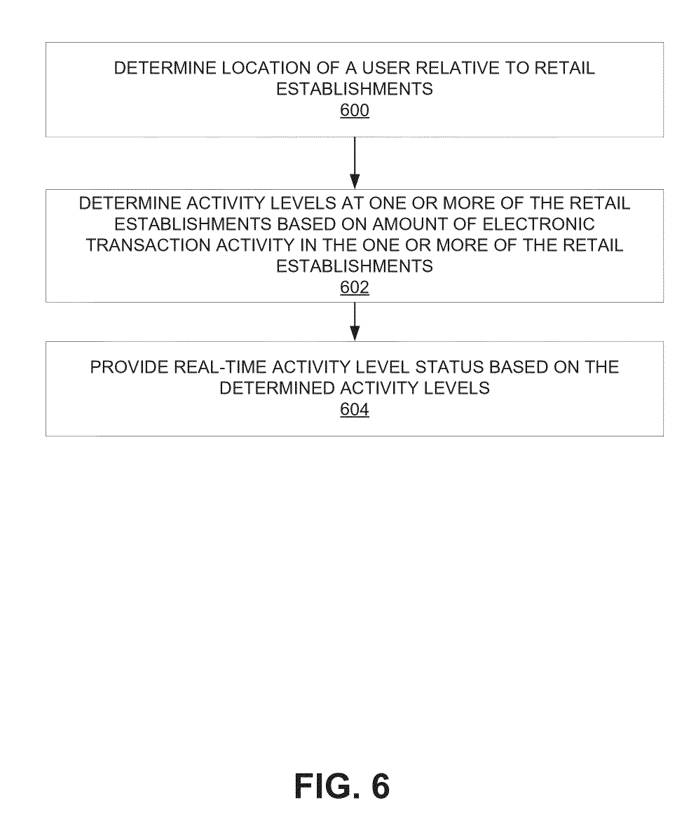

FIG. 6 illustrates a flow chart describing various processes that can be performed to determine the activity level associated with a point of interest in accordance with another embodiment of the present disclosure. At operation 600, the location of a user relative to retail establishments is determined. Again, location-based services/functionality can be leveraged in accordance with various embodiments to determine a location of the user. For example, and referring back to FIG. 2, server 114 of payment network 112 can access device 128 to obtain the location of the user (operating device 128) determined by location-based services/functionality resident on device 128 or via an API call made by device 128 to a third-party mapping application/service. Alternatively, server 114 may access location server 340 to obtain the location of device 128. Based on one or more parameters or preferences of the user, relevant retail establishments can be determined and recommended to the user. Again, server 114 may access location server 340 to determine the relevant retail establishments located appropriately proximate to device 128, e.g., if such information is not included in or cannot be determined from transaction processing or merchant information already known to payment network 112. At operation 602, activity levels at one or more of the retail establishments are determined based on the amount of electronic transaction activity in the one or more of the retail establishments. That is, activity levels can be determined based on the number of electronic transactions occurring within some predetermined time and/or the times between subsequent electronic transactions occurring within the predetermined time. Again, the time stamps associated with electronic transactions can be leveraged to ascertain this information. Server 114 and/or counter/timer module 126 can determine such activity levels. At operation 604, activity level status based on the determined activity levels is provided to the user (e.g., by server 114). Again, raw activity level information can be provided to the user, as well as enhanced predictive or estimated activity level information.

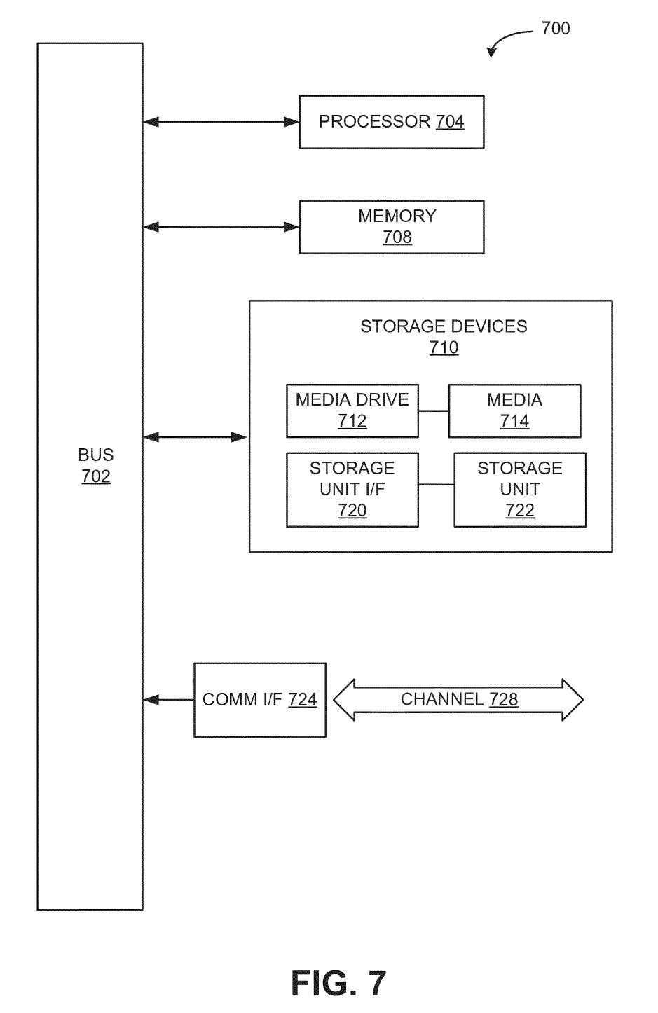

FIG. 7 illustrates an example computing module 700, an example of which may be a processor/controller resident on a device, such as a user device, or a processor/controller used to perform payment transactions, such as a server or counter/timer module (e.g., server 114 and counter/timer module 126 of FIG. 2), that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 7. Various embodiments are described in terms of this example-computing module 700. After reading this description, it will become apparent to a person skilled in the relevant art how to implement the application using other computing modules or architectures.

Referring now to FIG. 7, computing module 700 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 700 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 700 might include, for example, one or more processors, controllers, control modules, or other processing devices, such as a processor 704. Processor 704 might be implemented using a general-purpose or special-purpose processing engine such as, for example, a microprocessor, controller, or other control logic. In the illustrated example, processor 704 is connected to a bus 702, although any communication medium can be used to facilitate interaction with other components of computing module 700 or to communicate externally.

Computing module 700 might also include one or more memory modules, simply referred to herein as main memory 708. For example, preferably random access memory (RAM) or other dynamic memory might be used for storing information and instructions to be executed by processor 704. Main memory 708 might also be used for storing temporary variables or other intermediate information during execution of instructions to be executed by processor 704. Computing module 700 might likewise include a read only memory (“ROM”) or other static storage device coupled to bus 702 for storing static information and instructions for processor 704.

The computing module 700 might also include one or more various forms of information storage devices 710, which might include, for example, a media drive 712 and a storage unit interface 720. The media drive 712 might include a drive or other mechanism to support fixed or removable storage media 714. For example, a hard disk drive, a floppy disk drive, a magnetic tape drive, an optical disk drive, a CD or DVD drive (R or RW), or other removable or fixed media drive might be provided. Accordingly, storage media 714 might include, for example, a hard disk, a floppy disk, magnetic tape, cartridge, optical disk, a CD or DVD, or other fixed or removable medium that is read by, written to or accessed by media drive 712. As these examples illustrate, the storage media 714 can include a computer usable storage medium having stored therein computer software or data.

In alternative embodiments, information storage devices 710 might include other similar instrumentalities for allowing computer programs or other instructions or data to be loaded into computing module 700. Such instrumentalities might include, for example, a fixed or removable storage unit 722 and a storage unit interface 720. Examples of such storage units 722 and storage unit interfaces 720 can include a program cartridge and cartridge interface, a removable memory (for example, a flash memory or other removable memory module) and memory slot, a PCMCIA slot and card, and other fixed or removable storage units 722 and interfaces 720 that allow software and data to be transferred from the storage unit 722 to one or more components of computing module 700.

Computing module 700 might also include a communications interface 724. Communications interface 724 might be used to allow software and data to be transferred between computing module 700 and external devices. Examples of communications interface 724 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 724 might typically be carried on signals, which can be electronic, electromagnetic (which includes optical) or other signals capable of being exchanged by a given communications interface 724. These signals might be provided to communications interface 724 via a channel 728. This channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 708, storage unit interface 720, media 714, and channel 728. These and other various forms of computer program media or computer usable media may be involved in carrying one or more sequences of one or more instructions to a processing device for execution. Such instructions embodied on the medium are generally referred to as “computer program code” or a “computer program product” (which may be grouped in the form of computer programs or other groupings). When executed, such instructions might enable the computing module 700 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method, comprising:
accessing an authorization database to obtain a predetermined subset of authorization records pertaining to electronic transactions stored therein;
determining delta values between successive authorization records of the predetermined subset of authorization records; and
predicting an activity level at one or more merchants associated with the electronic transactions based on the determined delta values.

2. The method of claim 1, further comprising determining a location of a user device, wherein the one or more merchants associated with the electronic transactions are located at a predetermined proximity to the location of the user device.

3. The method of claim 1, wherein the predetermined subset of authorization records comprises authorization records associated with transactions occurring at the one or more merchants within a predetermined time period.

4. The method of claim 3, wherein the predetermined time period begins at a time associated with a query regarding the activity level at the one or more merchants received by a payment network from a user device.

5. The method of claim 4, further comprising accessing a categorization database and obtaining therefrom, indicia representative of the one or more merchants, the one or more merchants being commensurate with at least one parameter specified in the query regarding a type of service or product provided by the one or more merchants in which a user of the user device has an interest in purchasing.

6. The method of claim 5, wherein the accessing of the authorization database is based on the obtained indicia.

7. The method of claim 1, wherein the predicting of the activity level comprises translating the determined delta values into a wait time at the one or more merchants.

8. The method of claim 1, wherein the predicting of the activity level comprises averaging the determined delta values to predict a wait time at the one or more merchants.

9. The method of claim 1, further comprising repeating the accessing of the authorization database, the determining of the delta values, and the predicting of the activity level at periodic intervals.

10. A non-transitory computer-readable medium having computer executable program code embodied thereon, the computer executable program code configured to cause a computer system to:
determine a location of a user relative to retail establishments;
determine activity levels at one or more of the retail establishments based on an amount of electronic transaction activity in the one or more of the retail establishments; and
provide a real-time activity level status of the one or more of the retail establishments based on the determined activity levels.

11. The non-transitory computer-readable medium of claim 10, wherein the one or more of the retail establishments comprises retail establishments falling within at least one service or product category identified by the user.

12. The non-transitory computer-readable medium of claim 11, wherein the computer executable program code is configured to further cause the computer system to access a third-party category database to obtain indicia identifying the or more of the retail establishments.

13. The non-transitory computer-readable medium of claim 12, wherein the computer executable program code is configured to further cause the computer system to access an electronic transaction authorization database utilizing the obtained indicia to retrieve records indicative of the electronic transaction activity during a predetermined time period.

14. The non-transitory computer-readable medium of claim 13, wherein the computer executable program code configured to cause the computer system to determine the real-time activity levels at the one or more of the retail establishments comprises program code configured to cause the computer system to calculate durations of time between successive instances of electronic transaction activity within a predetermined time period.

15. The non-transitory computer-readable medium of claim 14, wherein the computer executable program code is configured to further cause the computer system to average the calculated durations of time between successive instances.

16. The non-transitory computer-readable medium of claim 14, wherein the computer executable program code is configured to access a payment network authorization database to retrieve the successive instances of electronic transaction activity.

17. The non-transitory computer-readable medium of claim 13, wherein the computer executable program code configured to cause the computer system to determine the real-time activity levels at the one or more of the retail establishments comprises program code configured to cause the computer system to calculate a number of electronic transactions occurring at the one or more of the retail establishments within a predetermined time period.

18. The non-transitory computer-readable medium of claim 10, wherein the computer executable program code is configured to further cause the computer system to provide a map on which the determined location of the user and the one or more of the retail establishments is displayed in conjunction with a visual representation of the real-time activity level status of the one or more of the retail establishments.

19. The non-transitory computer-readable medium of claim 18, wherein the visual representation of the real-time activity level status comprises an indication of a predicted wait time at the one or more of the retail establishments.

20. The non-transitory computer-readable medium of claim 10, wherein the computer executable program code is configured to further cause the computer system to periodically repeat the determining of the real-time activity levels at the one or more of the retail establishments and periodically provide up-to-date activity level status of the one or more of the retail establishments.
